(19) United States
(12) Patent Application Publication
(10) Pub. No.: US 2026/0159114 A1
(43) Pub. Date: Jun. 11, 2026

(54) SYSTEM AND METHOD FOR CONTROLLING ELECTRONIC DEVICES

(71) Applicant: GM Global Technology Operations LLC, Detroit, MI (US)

(72) Inventors: Manuel Forero Rueda, Royal Oak, MI (US); Maureen Elizabeth August, Grosse Pointe Woods, MI (US); Akilesh Rajavenkatanarayanan, Clinton Township, MI (US)

(21) Appl. No.: 18/971,611

(22) Filed: Dec. 6, 2024

(51) Int. Cl. B60W 50/16; B60R 16/023; B60W 50/14

(52) U.S. Cl. CPC B60W 50/16; B60R 16/023; B60W 2050/143; B60W 2050/146; B60W 2540/215; B60W 2540/225

(57) ABSTRACT

A system for controlling vehicle components for a vehicle is provided. The system may include a plurality of vehicle components, a universal human-interface-device (HID) operable to receive an occupant input and control any of the plurality of vehicle components, and a vehicle controller in electrical communication with the plurality of vehicle components and the universal HID. The vehicle controller is programmed to determine a selected component of the plurality of vehicle components. The vehicle controller is programmed to receive the occupant input using the universal HID. The vehicle controller is programmed to adjust an operation of the selected component based at least in part on the occupant input.

### INTRODUCTION

The present disclosure relates to systems and methods for human-machine interfaces for controlling electronic devices, including vehicle components.

Electronic devices are often used to enhance user convenience. Vehicles, for example, may include infotainment systems, ventilation systems, lighting systems, window actuators, and more. Homes, for example, may include lights, door locks, climate control systems, stereo systems and more. Human-machine interfaces (HMIs) are used to allow users to interact with electronic devices. In some examples, HMIs utilize physical controls, such as, for example, buttons, switches, knobs, levers, and the like to facilitate user interaction. In other examples, HMIs utilize digital interfaces, such as, for example, touchscreens to facilitate user interaction. In yet other examples, HMIs utilize audible interfaces, such as, for example, speech synthesis, voice recognition, and the like to facilitate user interaction. In some examples, HMIs also provide feedback to the user, such as, for example, visual feedback (e.g., using lights or user-interface elements), audible feedback (e.g., using sound), tactile feedback (e.g., using vibration), and more.

While current human-machine interface systems and methods achieve their intended purpose, there is a need for a new and improved system and method for controlling electronic devices.

### SUMMARY

According to several aspects, a system for controlling vehicle components for a vehicle is provided. The system may include a plurality of vehicle components, a universal human-interface-device (HID) operable to receive an occupant input and control any of the plurality of vehicle components, and a vehicle controller in electrical communication with the plurality of vehicle components and the universal HID. The vehicle controller is programmed to determine a selected component of the plurality of vehicle components. The vehicle controller is programmed to receive the occupant input using the universal HID. The vehicle controller is programmed to adjust an operation of the selected component based at least in part on the occupant input.

In another aspect of the present disclosure, the system further may include an occupant monitoring system (OMS) in electrical communication with the vehicle controller and operable to determine a gaze direction of a vehicle occupant. To determine the selected component, the vehicle controller is further programmed to receive an activation occupant input using the universal HID. To determine the selected component, the vehicle controller is further programmed to determine the gaze direction of the vehicle occupant using the OMS in response to receiving the activation occupant input. To determine the selected component, the vehicle controller is further programmed to identify the selected component based at least in part on the gaze direction.

In another aspect of the present disclosure, to determine the selected component, the vehicle controller is further programmed to receive a first selection occupant input using the universal HID. To determine the selected component, the vehicle controller is further programmed to indicate a first component of the plurality of vehicle components to a vehicle occupant. To determine the selected component, the vehicle controller is further programmed to receive a confirmation occupant input using the universal HID. To determine the selected component, the vehicle controller is further programmed to determine the first component to be the selected component in response to receiving the confirmation occupant input.

In another aspect of the present disclosure, to determine the selected component, the vehicle controller is further programmed to receive a second selection occupant input using the universal HID. To determine the selected component, the vehicle controller is further programmed to indicate a second component of the plurality of vehicle components to the vehicle occupant in response to receiving the second selection occupant input.

In another aspect of the present disclosure, the system further may include a light source in electrical communication with the vehicle controller and disposed within an interior of the vehicle. To indicate the first component, the vehicle controller is further programmed to illuminate the light source to visually indicate the first component to the vehicle occupant.

In another aspect of the present disclosure, the light source further may include at least one of: a spotlight, a laser, a projector, and one or more light emitting diodes (LEDs) operable to selectively illuminate one or more of the plurality of vehicle components.

In another aspect of the present disclosure, the system further may include an audio source in electrical communication with the vehicle controller and disposed within an interior of the vehicle. To indicate the first component, the vehicle controller is further programmed to produce a sound using the audio source to audibly indicate the first component to the vehicle occupant.

In another aspect of the present disclosure, the universal HID includes one or more tactile interfaces fixed within reach of one or more vehicle occupants within an interior of the vehicle.

In another aspect of the present disclosure, to receive the occupant input using the universal HID and adjust the operation of the selected component, the vehicle controller is further programmed to receive a control occupant input using the universal HID. To receive the occupant input using the universal HID and adjust the operation of the selected component, the vehicle controller is further programmed to adjust the operation of the selected component based at least in part on the control occupant input. To receive the occupant input using the universal HID and adjust the operation of the selected component, the vehicle controller is further programmed to provide haptic feedback or force feedback using the universal HID in response to adjusting the operation of the selected component.

In another aspect of the present disclosure, the plurality of vehicle components includes at least one of: a window of the vehicle, a ventilation system of the vehicle, an infotainment system of the vehicle, a door of the vehicle, and a seat of the vehicle. To adjust the operation of the selected component, the vehicle controller is further programmed to adjust a position of the window based at least in part on the control occupant input in response to determining that the selected component is the window. To adjust the operation of the selected component, the vehicle controller is further programmed to adjust at least one of: a temperature setpoint and an airflow level based at least in part on the control occupant input in response to determining that the selected component is the ventilation system. To adjust the operation of the selected component, the vehicle controller is further programmed to adjust an audio playback volume based at least in part on the control occupant input in response to determining that the selected component is the infotainment system. To adjust the operation of the selected component, the vehicle controller is further programmed to adjust at least one of: a door latch state and a door lock state based at least in part on the control occupant input in response to determining that the selected component is the door. To adjust the operation of the selected component, the vehicle controller is further programmed to adjust a seat position based at least in part on the control occupant input in response to determining that the selected component is the seat.

According to several aspects, a method for controlling vehicle components for a vehicle is provided. The method may include determining a selected component of a plurality of vehicle components. The method further may include receiving an occupant input using a universal human-interface-device (HID). The method further may include adjusting an operation of the selected component based at least in part on the occupant input.

In another aspect of the present disclosure, determining the selected component further may include receiving an activation occupant input from a vehicle occupant using the universal HID. Determining the selected component further may include determining a gaze direction of the vehicle occupant using an occupant monitoring system (OMS) in response to receiving the activation occupant input. Determining the selected component further may include identifying the selected component based at least in part on the gaze direction.

In another aspect of the present disclosure, determining the selected component further may include receiving a first selection occupant input using the universal HID. Determining the selected component further may include indicating a first component of the plurality of vehicle components to a vehicle occupant. Determining the selected component further may include receiving a confirmation occupant input using the universal HID. Determining the selected component further may include determining the first component to be the selected component in response to receiving the confirmation occupant input.

In another aspect of the present disclosure, indicating the first component further may include illuminating a light source to visually indicate the first component to the vehicle occupant. The light source includes at least one of: a spotlight, a laser, a projector, and one or more light emitting diodes (LEDs) operable to selectively illuminate one or more of the plurality of vehicle components.

In another aspect of the present disclosure, receiving the occupant input using the universal HID further may include receiving the occupant input using the universal HID. The universal HID includes one or more tactile interfaces fixed within reach of one or more vehicle occupants within an interior of the vehicle. The universal HID is operable to provide haptic feedback.

In another aspect of the present disclosure, receiving the occupant input using the universal HID and adjusting the operation of the selected component further may include receiving a control occupant input using the universal HID. Receiving the occupant input using the universal HID and adjusting the operation of the selected component further may include adjusting the operation of the selected component based at least in part on the control occupant input. Receiving the occupant input using the universal HID and adjusting the operation of the selected component further may include providing haptic feedback using the universal HID in response to adjusting the operation of the selected component.

In another aspect of the present disclosure, adjusting the operation of the selected component further may include adjusting a position of a window based at least in part on the control occupant input in response to determining that the selected component is the window. Adjusting the operation of the selected component further may include adjusting at least one of: a temperature setpoint and an airflow level based at least in part on the control occupant input in response to determining that the selected component is a ventilation system. Adjusting the operation of the selected component further may include adjusting an audio playback volume based at least in part on the control occupant input in response to determining that the selected component is an infotainment system. Adjusting the operation of the selected component further may include adjusting at least one of: a door latch state and a door lock state based at least in part on the control occupant input in response to determining that the selected component is a door. Adjusting the operation of the selected component further may include adjusting a seat position based at least in part on the control occupant input in response to determining that the selected component is a seat.

According to several aspects, a system for controlling electronic devices is provided. The system may include a plurality of electronic devices, a universal human-interface-device (HID) operable to receive a user input and control any of the plurality of electronic devices, and a controller in electrical communication with the plurality of electronic devices and the universal HID. The controller is programmed to determine a selected device of the plurality of electronic devices using the universal HID based at least in part on an orientation of the universal HID in three-dimensional space. The controller is further programmed to receive the user input using the universal HID. The controller is further programmed to adjust an operation of the selected device based at least in part on the user input.

In another aspect of the present disclosure, to determine the selected device, the controller is further programmed to determine the orientation of the universal HID in three-dimensional space. To determine the selected device, the controller is further programmed to determine a pointing direction of the universal HID based at least in part on the orientation of the universal HID. To determine the selected device, the controller is further programmed to determine the selected device based at least in part on the pointing direction of the universal HID.

In another aspect of the present disclosure, to receive the user input using the universal HID and adjust the operation of the selected device, the controller is further programmed to receive a control user input using the universal HID. The control user input includes at least one of: actuation of a button of the universal HID and performance of a physical gesture using the universal HID. To receive the user input using the universal HID and adjust the operation of the selected device, the controller is further programmed to adjust the operation of the selected device based at least in part on the control user input. To receive the user input using the universal HID and adjust the operation of the selected device, the controller is further programmed to provide haptic feedback using the universal HID in response to adjusting the operation of the selected device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a first exemplary embodiment for controlling electronic devices, according to an exemplary embodiment;

FIG. 2 is a schematic diagram of a second exemplary embodiment for controlling electronic devices, according to an exemplary embodiment;

FIG. 3 is a flowchart diagram of a method for controlling electronic devices, according to an exemplary embodiment;

FIG. 4 is a flowchart of a first exemplary embodiment of a method for selecting an electronic device for the method of FIG. 3, according to an exemplary embodiment;

FIG. 5 is a schematic diagram of an exemplary vehicle interior including a vehicle occupant, according to an exemplary embodiment;

FIG. 6 is a flowchart of a second exemplary embodiment of a method for selecting an electronic device for the method of FIG. 3, according to an exemplary embodiment; and

FIG. 7 is a flowchart of a third exemplary embodiment of a method for selecting an electronic device for the method of FIG. 3, according to an exemplary embodiment.

### DETAILED DESCRIPTION

The following description is merely exemplary in nature and is not intended to limit the present disclosure, application, or uses.

In aspects of the present disclosure, users may desire to adjust the operation of electronic devices (such as, for example, vehicle components, smart-home devices, and/or the like). However, in environments with many devices, users may need to interact with many different interfaces or human-interface-devices to select a device to control and to control the selected device. Therefore, the present disclosure provides a new improved system and method for controlling electronic devices which requires minimal effort on the part of the user to select a device to control and which provides a consistent control interface across multiple devices.

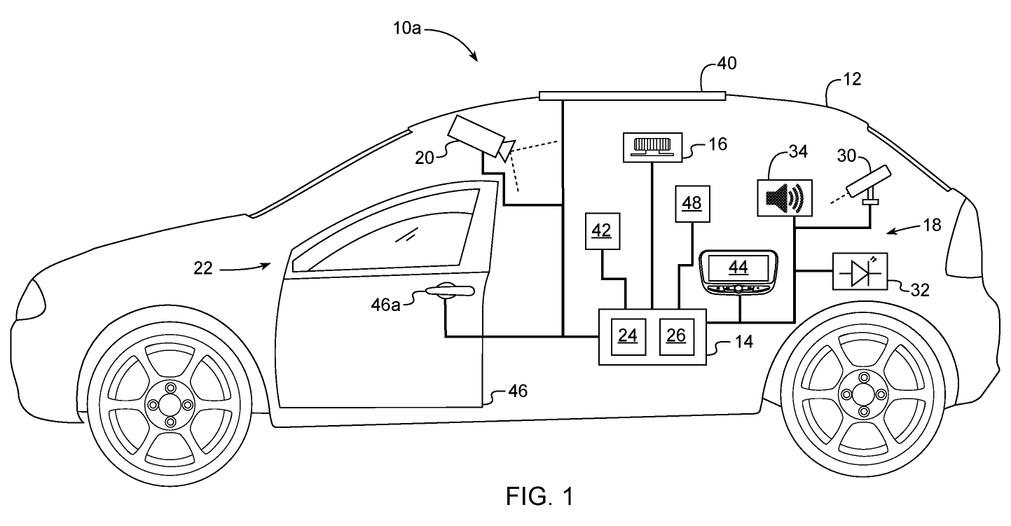

Referring to FIG. 1, a first exemplary embodiment of a system for controlling electronic devices is illustrated and generally indicated by reference number 10a. The system 10a is described in the context of an exemplary vehicle 12 and is also referred to as a system for controlling vehicle components. While a passenger vehicle is illustrated, it should be appreciated that the vehicle 12 may be any type of vehicle without departing from the scope of the present disclosure. The system 10a generally includes a vehicle controller 14, a universal human-interface-device (HID) 16, one or more indicator devices 18, and occupant monitoring system (OMS) 20, and a plurality of vehicle components 22.

The vehicle controller 14 is used to implement a method 100 for controlling vehicle components or electronic devices, as will be described below. The vehicle controller 14 includes at least one processor 24 and a non-transitory computer readable storage device or media 26. The processor 24 may be a custom made or commercially available processor, a central processing unit (CPU), a graphics processing unit (GPU), an auxiliary processor among several processors associated with the vehicle controller 14, a semiconductor-based microprocessor (in the form of a microchip or chip set), a macroprocessor, a combination thereof, or generally a device for executing instructions.

The computer readable storage device or media 26 may include volatile and nonvolatile storage in read-only memory (ROM), random-access memory (RAM), and keep-alive memory (KAM), for example. KAM is a persistent or non-volatile memory that may be used to store various operating variables while the processor 24 is powered down. The computer-readable storage device or media 26 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 14 to control various systems of the vehicle 12.

The vehicle controller 14 may also include multiple vehicle controllers which are in electrical communication with each other. The vehicle controller 14 may be inter-connected with additional systems and/or vehicle controllers of the vehicle 12, allowing the vehicle controller 14 to access data such as, for example, speed, acceleration, braking, and steering angle of the vehicle 12.

The vehicle controller 14 is in electrical communication with the universal HID 16, the one or more indicator devices 18, the OMS 20, and the plurality of vehicle components 22. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the vehicle controller 14 are within the scope of the present disclosure. It should further be understood that, in the scope of the present disclosure, electrical communication also includes power and/or energy transfer between electrical devices (e.g., using conducting wires and/or wireless power transmission techniques).

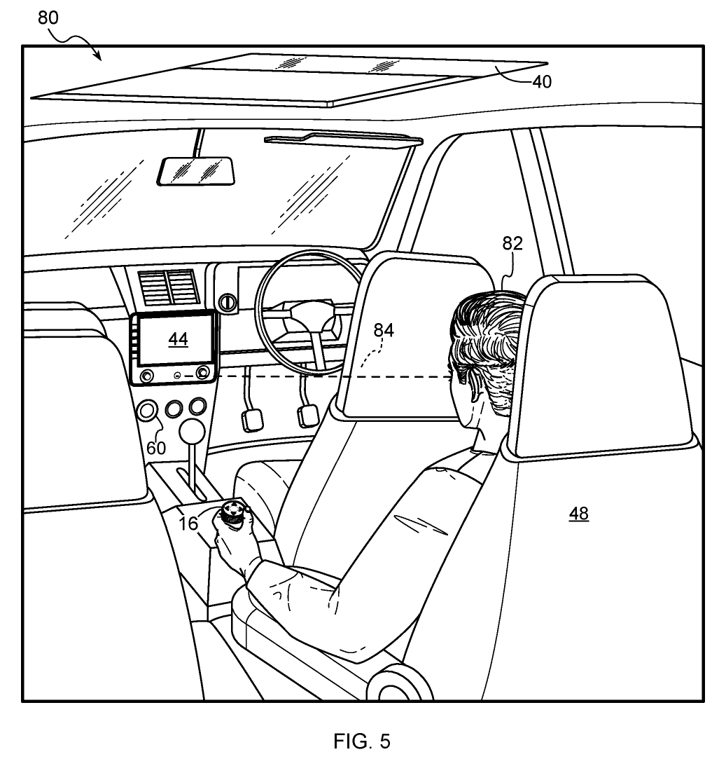

The universal HID 16 is used to receive occupant or user inputs and control any of the plurality of vehicle components 22. In an exemplary embodiment, the universal HID 16 includes one or more tactile interfaces disposed within an interior of the vehicle 12 within reach of one or more vehicle occupants 82 (FIG. 5) of the vehicle 12. In a non-limiting example, the universal HID 16 includes one or more knobs, buttons, switches, joysticks, rotary switches, capacitive switches, and/or the like. In another non-limiting example, the universal HID 16 includes one or more touchpads, touchscreens, trackpads, and/or the like. In a non-limiting example, the universal HID 16 includes capabilities to provide haptic feedback, including, for example, a vibration motor. In another non-limiting example, the universal HID 16 further includes one or more microphones for receiving speech provided by the occupant or user and performing speech recognition to determine occupant or user inputs. It should be understood that the universal HID 16 may include any interface device operable with one or more hands of the vehicle occupant 82 (FIG. 5) or user.

In an exemplary embodiment, the universal HID 16 is fixed within the interior of the vehicle 12, for example, within a center console, an instrument panel, a dashboard, a door panel, an armrest, and/or the like. In another exemplary embodiment, the universal HID 16 is a handheld remote which may be manipulated in three-dimensional space by the vehicle occupant 82 (FIG. 5) or user. The universal HID 16 is in electrical communication with the vehicle controller 14, as discussed above. In some embodiments, the vehicle controller 14 is contained within the universal HID 16.

The one or more indicator devices 18 are used to provide information to the vehicle occupant 82 (FIG. 5) or user. In an exemplary embodiment, the one or more indicator devices 18 are used to highlight, announce, and/or otherwise indicate one or more of the plurality of vehicle components 22 to the vehicle occupant 82 (FIG. 5) or user, as will be discussed in greater detail below in reference to the method 100. In an exemplary embodiment, the one or more indicator devices 18 includes at least one of: a laser 30, one or more light emitting diodes (LEDs) 32, and an audio source 34.

The laser 30 is used to point to one of the plurality of vehicle components 22 using a focused beam of light. In a non-limiting example, the laser 30 is affixed to an electronically controllable and movable mounting apparatus in electrical communication with the vehicle controller 14 such that at least a pitch and yaw of the laser 30 is adjustable to aim the focused beam of light at one or more of the plurality of vehicle components 22. In a non-limiting example, the laser 30 is affixed to a headliner of the vehicle 12. The laser 30 is in electrical communication with the vehicle controller 14.

The one or more LEDs 32 are used to produce light to draw the vehicle occupant 82 (FIG. 5) or user’s attention to one or more of the plurality of vehicle components 22. In an exemplary embodiment, the one or more LEDs 32 are arranged in LED strips and/or strings disposed throughout the interior of the vehicle 12. In a non-limiting example, one or more LEDs 32 are disposed on or near the window 40 (discussed below). Therefore, by illuminating the one or more LEDs 32, the vehicle occupant 82 (FIG. 5) or user’s attention is drawn to the window 40 (discussed below).

In another exemplary embodiment, the one or more LEDs 32 are arranged in an array to function as a spotlight. In a non-limiting example, the one or more LEDs 32 are affixed to an electronically controllable and movable mounting apparatus in electrical communication with the vehicle controller 14 such that at least a pitch and yaw of the one or more LEDs 32 is adjustable to aim the spotlight at one or more of the plurality of vehicle components 22. In a non-limiting example, the spotlight is affixed to the headliner of the vehicle 12.

In another exemplary embodiment, the one or more LEDs 32 are arranged in an array to function as a projector. In a non-limiting example, the one or more LEDs 32 are individually controllable by the vehicle controller 14 to provide a field-of-projection within the interior of the vehicle 12. The vehicle controller 14 is configured to use the one or more LEDs 32 to display symbols, graphics, and/or text to indicate (i.e., draw the vehicle occupant 82 (FIG. 5) or user’s attention to) one or more of the plurality of vehicle components 22. In a non-limiting example, the projector is affixed to the headliner of the vehicle 12. The one or more LEDs 32 are in electrical communication with the vehicle controller 14 as discussed above.

The audio source 34 is used to provide audible feedback to the vehicle occupant 82 (FIG. 5) or user. In an exemplary embodiment, the audio source 34 is a speaker such as, for example, an electroacoustic transducer, for converting electrical signals into sound waves hearable by the vehicle occupant 82 (FIG. 5) or user. In a non-limiting example, the vehicle controller 14 uses speech synthesis and the audio source 34 to provide audible natural language announcements to indicate (i.e., draw the vehicle occupant 82 (FIG. 5) or user’s attention to) one or more of the plurality of vehicle components 22. The audio source 34 is in electrical communication with the vehicle controller 14, as discussed above.

It should be understood that the one or more indicator devices 18 may include additional light sources, light arrangements, projector types, audio sources, and/or the like without departing from the scope of the present disclosure.

The occupant monitoring system (OMS) 20 is used to determine a gaze direction of the vehicle occupant 82 (FIG. 5) within the vehicle 12. In an exemplary embodiment, the OMS 20 includes one or more infrared (IR) cameras positioned within the interior of the vehicle 12 to capture images of the vehicle occupant 82 (FIG. 5). The OMS further includes an image processor (not shown) in electrical communication with the IR cameras. The IR cameras capture high-resolution images of the occupant’s face and eyes and the image processor analyzes the images to determine the occupant's gaze direction. The OMS 20 utilizes reflected IR light from the eyes and surrounding facial features to track the orientation and position of the eyes, allowing the OMS 20 to calculate the gaze direction based on the processed image data. The OMS 20 is in electrical communication with the vehicle controller 14 as discussed above.

The plurality of vehicle components 22 are used to provide various features to occupants of the vehicle 12. In an exemplary embodiment, the plurality of vehicle components 22 includes at least one of: a window 40 of the vehicle 12, a ventilation system 42 of the vehicle 12, an infotainment system 44 of the vehicle 12, a door 46 of the vehicle 12, and a seat 48 of the vehicle 12.

The window 40 is used to provide visibility and/or fresh air to the vehicle occupant 82 (FIG. 5) or the user. In the exemplary embodiment shown in FIG. 1, the window 40 is included as part of a sunroof of the vehicle 12. The window 40 may also be included in the door 46 of the vehicle 12. It should be understood that the window 40 may be any transparent or semi-transparent component allowing the vehicle occupant 82 (FIG. 5) or user to look outside of the vehicle 12. The window 40 further includes an actuation mechanism (not shown) which allows the window 40 to be opened and closed (i.e., by raising, lowering, and/or tilting the window 40). In a non-limiting example, the actuation mechanism is electrically driven and in electrical communication with the vehicle controller 14. Accordingly, the vehicle controller 14 may send signals to the actuation mechanism to open and close the window 40.

The ventilation system 42 is used to control airflow within the interior of the vehicle 12. The ventilation system 42 is used to improve occupant comfort by regulating temperature and humidity inside of the vehicle 12. In an exemplary embodiment, the ventilation system 42 includes a blower (not shown), air baffles (not shown), a temperature control (not shown), ventilation outlets (not shown), and a ventilation interface 60 (FIG. 5).

The blower is an electrically driven fan which generates the airflow in the ventilation system 42. The air baffles are electrically actuated surfaces within the ventilation system 42 which are used to direct the airflow within the ventilation system 42. By moving the air baffles, the ventilation system 42 may control a proportion of a total volume of the airflow generated by the blower which is directed to each of the ventilation outlets. The temperature control allows the ventilation system 42 to control a temperature of the airflow in the entire ventilation system 42. The ventilation outlets provide the airflow to the interior of the vehicle 12. In an exemplary embodiment, the ventilation outlets are configured to provide airflow to occupants of the vehicle 12 to improve occupant comfort. The ventilation interface 60 (FIG. 5) is used to allow the vehicle occupant 82 (FIG. 5) to control the ventilation system 42. In a non-limiting example, the ventilation interface 60 includes one or more knobs, buttons, sliders, touchscreens, or other controls allowing the vehicle occupant 82 (FIG. 5) to adjust the blower, air baffles, and temperature control of the ventilation system 42.

The ventilation system 42 is in electrical communication with the vehicle controller 14 as described above. The blower, air baffles, and temperature control of the ventilation system 42 may be controlled automatically by the vehicle controller 14, or in response to an input by the vehicle occupant 82 (FIG. 5) to the ventilation interface 60.

The infotainment system 44 is used to provide information and entertainment to the vehicle occupant 82 (FIG. 5) and/or to provide vehicle control capabilities to the vehicle occupant 82 (FIG. 5). In an exemplary embodiment, the infotainment system 44 includes a human-machine interface (HMI), a sound system, and a navigation system. The HMI is used to provide information to the vehicle occupant 82 (FIG. 5). In an exemplary embodiment, the HMI is a display located in view of the vehicle occupant 82 (FIG. 5) and capable of displaying text, graphics and/or images. It is to be understood that HMI display systems including LCD displays, LED displays, and the like are within the scope of the present disclosure. Further exemplary embodiments where the HMI is disposed in a rearview mirror are also within the scope of the present disclosure.

In another exemplary embodiment, the HMI includes a head-up display (HUD) configured to provide information to the vehicle occupant 82 (FIG. 5) by projecting text, graphics, and/or images upon the windscreen of the vehicle 12. The text, graphics, and/or images are reflected by the windscreen of the vehicle 12 and are visible to the vehicle occupant 82 (FIG. 5) without looking away from a roadway ahead of the vehicle 12. In another exemplary embodiment, the HMI includes an augmented reality head-up display (AR-HUD). The AR-HUD is a type of HUD configured to augment the occupant’s vision of the roadway ahead of the vehicle 12 by overlaying text, graphics, and/or images on physical objects in the environment surrounding the vehicle 12 within a field-of-view of the vehicle occupant 82 (FIG. 5). In a non-limiting example, the vehicle controller 14 may control one or more operating parameters of the HMI, including, for example, a display brightness, a display color, a display notification, and/or the like.

In an exemplary embodiment, the vehicle occupant 82 (FIG. 5) may interact with the infotainment system 44 using a human-interface device (HID), including, for example, a touchscreen, an electromechanical switch, a capacitive switch, a rotary knob, and the like. It should be understood that additional systems for displaying information to the vehicle occupant 82 (FIG. 5) are also within the scope of the present disclosure.

The sound system is used to provide entertainment to the vehicle occupant 82 (FIG. 5) within the interior cabin of the vehicle 12. In a non-limiting example, the sound system includes an amplifier and one or more loudspeakers. The sound system is operable to play sounds such as, for example, music, for entertainment of the vehicle occupant 82 (FIG. 5). In a non-limiting example, the sounds are provided to the amplifier from various sources, including, for example, a portable media device, an MP3 player, a smartphone, an internet connection, an AM/FM radio receiver, and/or the like. In an exemplary embodiment, the sound system is controllable by the vehicle occupant 82 (FIG. 5) via the infotainment system 44, for example, by interaction with the HID, as discussed above. Furthermore, the vehicle controller 14 may adjust one or more operating parameters (e.g., a music playback volume, a music playback genre, and/or the like) of the sound system via electrical communication with the infotainment system 44, as will be discussed in greater detail below.

The navigation system is used to provide the vehicle occupant 82 (FIG. 5) with information about navigation routes and destinations while operating the vehicle 12. In an exemplary embodiment, the navigation system includes a global navigation satellite system (GNSS). The GNSS is used to determine a geographical location of the vehicle 12. In an exemplary embodiment, the GNSS is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the vehicle 12 based on the signals received by the GPS receiver antenna. In an exemplary embodiment, the GNSS additionally includes a map. The map includes information about infrastructure such as municipality borders, roadways, railways, sidewalks, buildings, and the like. Therefore, the geographical location of the vehicle 12 is contextualized using the map information. In a non-limiting example, the map is retrieved from a remote source using a wireless connection. In another non-limiting example, the map is stored in a database of the GNSS. It should be understood that various additional types of satellite-based radionavigation systems, such as, for example, the Global Positioning System (GPS), Galileo, GLONASS, and the BeiDou Navigation Satellite System (BDS) are within the scope of the present disclosure.

Based on the geographical location of the vehicle and the map information obtained from the GNSS, the navigation system calculates an optimal route to a destination selected by the vehicle occupant 82 (FIG. 5). In an exemplary embodiment, the navigation system is controllable by the vehicle occupant 82 (FIG. 5) for selection of destination and route parameters via the infotainment system 44, for example, by interaction with the HID, as discussed above. The infotainment system 44 is in electrical communication with the vehicle controller 14 as described above.

The door 46 is used to provide entry into the interior of the vehicle 12. In an exemplary embodiment, the door 46 includes a door latch and lock mechanism 46a. The door latch and lock mechanism 46a is used to latch the door 46 in a closed position and lock the door 46 to prevent unlatching and opening of the door 46. In an exemplary embodiment, the door latch and lock mechanism 46a is configured to be both manually operated by the vehicle occupant 82 (FIG. 5) and electronically operated by the vehicle controller 14 such that the vehicle controller 14 may transmit electrical signals to both latch/unlatch and lock/unlock the door 46. The door latch and lock mechanism 46a is in electrical communication with the vehicle controller 14 as described above.

The seat 48 is used to provide a comfortable seating position for the vehicle occupant 82 (FIG. 5). In a non-limiting example, the seat 48 is a driver’s seat of the vehicle 12 disposed near a steering wheel and/or driving pedals of the vehicle 12. In another non-limiting example, the seat 48 is a passenger’s seat disposed adjacent to the driver’s seat and/or in a rear passenger compartment of the vehicle 12. It should be understood that the seat 48 may include any seat of the vehicle 12. In an exemplary embodiment, the seat 48 is adjustable in one or more axes, such as forward, backward, upward, or downward, to achieve an optimal seating position. In a non-limiting example, the seat 48 includes multiple actuators (not shown). Each actuator is configured to adjust a specific axis of the seat position. In a non-limiting example, the actuators are controllable by buttons, switches, and/or knobs disposed within the vehicle 12. In another non-limiting example, the actuators are in electrical communication with the vehicle controller 14 as discussed above.

It should be understood that the plurality of vehicle components 22 discussed above are merely exemplary in nature, and that the plurality of vehicle components 22 may further include any additional electronically controllable components of the vehicle 12, such as, for example, storage compartments (e.g., a glovebox), lights, mirrors (e.g., rear-view and/or side-view mirrors), and/or the like.

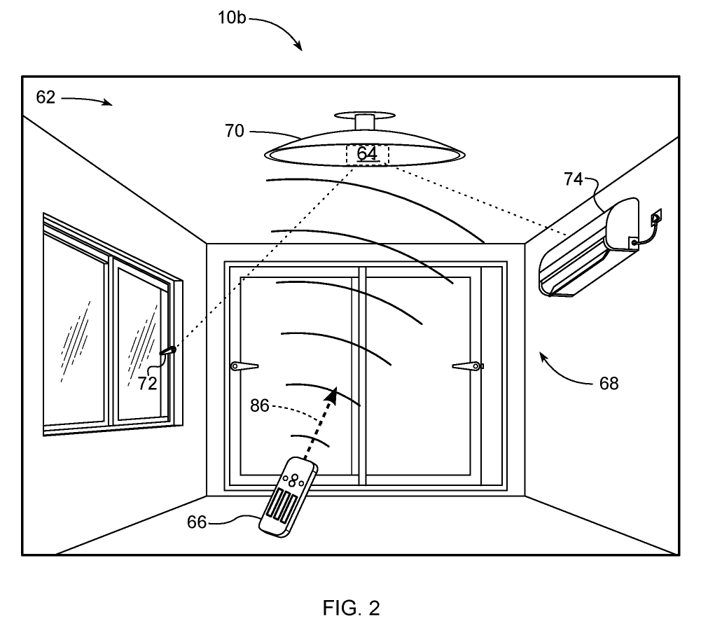

Referring to FIG. 2, a second exemplary embodiment of a system for controlling electronic devices is illustrated and generally indicated by reference number 10b. The system 10b is described in the context of an exemplary room 62. While a residential living area is illustrated, it should be appreciated that the room 62 may be any type of room without departing from the scope of the present disclosure. The system 10b generally includes a room controller 64, a hand-held universal HID 66, and a plurality of electronic devices 68.

The room controller 64 is used to control the system 10b and execute the method 100. In an exemplary embodiment, the room controller 64 is substantially similar in structure, components, and operation to the vehicle controller 14 discussed above. In a non-limiting example, the room controller 64 is integrated into one of the plurality of electronic devices 68 as shown in FIG. 2. In a non-limiting example, the room controller 64 further includes wireless reception capabilities to receive signals from the hand-held universal HID 66 and determine an orientation of the hand-held universal HID 66 as will be discussed in greater detail below. In an exemplary embodiment, the room controller 64 is configured to receive user commands from the hand-held universal HID 66 and communicate with and control each of the plurality of electronic devices 68.

The room controller 64 is in electrical communication with the hand-held universal HID 66 and the plurality of electronic devices 68. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the room controller 64 are within the scope of the present disclosure. It should further be understood that, in the scope of the present disclosure, electrical communication also includes power and/or energy transfer between electrical devices (e.g., using conducting wires and/or wireless power transmission techniques).

The hand-held universal HID 66 is used to receive user inputs and control any of the plurality of electronic devices 68. In an exemplary embodiment, the hand-held universal HID 66 is substantially similar in structure, components, and operation to the universal HID 16 discussed above in reference to the system 10a. Furthermore, the hand-held universal HID 66 is configured to be hand-held and manipulated in three-dimensional space to receive user inputs and control any of the plurality of electronic devices 68. In a non-limiting example, the hand-held universal HID 66 further includes one or more position and orientation sensors, such as, for example, gyroscopes, accelerometers, and/or the like. The hand-held universal HID 66 further may include one or more transmitters such as, for example, infrared (IR) emitters, BLUETOOTH transceivers, wireless local area network (WLAN) transceivers, and/or the like for transmitting control and orientation data to the room controller 64. In a non-limiting example, the hand-held universal HID 66 further includes one or more buttons, switches, joysticks, knobs, touchpads, touchscreens, and/or the like for receiving user inputs. In a non-limiting example, the hand-held universal HID 66 further includes capabilities for providing visual, audible, haptic, and/or force feedback to the user. The hand-held universal HID 66 is in electrical communication with the room controller 64 as discussed above.

The plurality of electronic devices 68 are used to provide various features to occupants or users of the room 62. In an exemplary embodiment, the plurality of electronic devices 68 includes at least one of: a room lamp 70, a room window lock 72, and a room ventilation system 74.

The room lamp 70 is used to provide illumination within the room 62. In an exemplary embodiment, the room lamp 70 also houses the room controller 64. It should be understood that the room controller 64 may be integrated into any of the plurality of electronic devices 68, the hand-held universal HID 66, or as a standalone device within the scope of the present disclosure. In an exemplary embodiment, the room lamp 70 includes one or more switches, relays, or other electronic circuits allowing the room lamp 70 to be electronically controlled via wired or wireless communication with the room controller 64.

The room window lock 72 is used to secure a window of the room 62 to prevent opening of the window. In an exemplary embodiment, the room window lock 72 includes one or more switches, relays, solenoids, motors, and/or other electronic circuits and/or electromechanical components allowing the room window lock 72 to be electronically controlled (i.e., locked and unlocked) via wired or wireless communication with the room controller 64.

The room ventilation system 74 is used to control a climate within the room 62. In an exemplary embodiment, the room ventilation system 74 includes an air-conditioning system and/or a heating system. In an exemplary embodiment, the room ventilation system 74 includes one or more switches, relays, solenoids, motors, and/or other electronic circuits and/or electromechanical components allowing the room ventilation system 74 to be electronically controlled (i.e., activating/deactivating the room ventilation system 74, changing a temperature setpoint of the room ventilation system 74, etc.) via wired or wireless communication with the room controller 64.

In an exemplary embodiment, each of the plurality of electronic devices 68 are in wired or wireless electrical communication with each other. In a non-limiting example, each of the plurality of electronic devices 68 participate in a peer-to-peer network, a mesh network, a wireless local area network (WLAN), and/or the like. Therefore, the room controller 64 provides commands which control each of the plurality of electronic devices 68.

It should be understood that the plurality of electronic devices 68 discussed above are merely exemplary in nature, and that the plurality of electronic devices 68 may further include any additional electronically controllable devices in the room 62, such as, for example, additional light sources, door/window locks, fans, appliances (e.g., a coffee maker), entertainment devices (e.g., televisions, radios, stereo systems, etc.), and/or the like.

It should also be understood that the systems 10a and 10b are merely exemplary in nature, and that the present disclosure is also applicable to various additional applications, such as, for example, entertainment (e.g., controlling a light show), heavy industry (e.g., controlling heavy machinery/equipment), logistics (e.g., controlling shipping docks and facilities), and other vehicles (e.g., aircraft, watercraft, etc.).

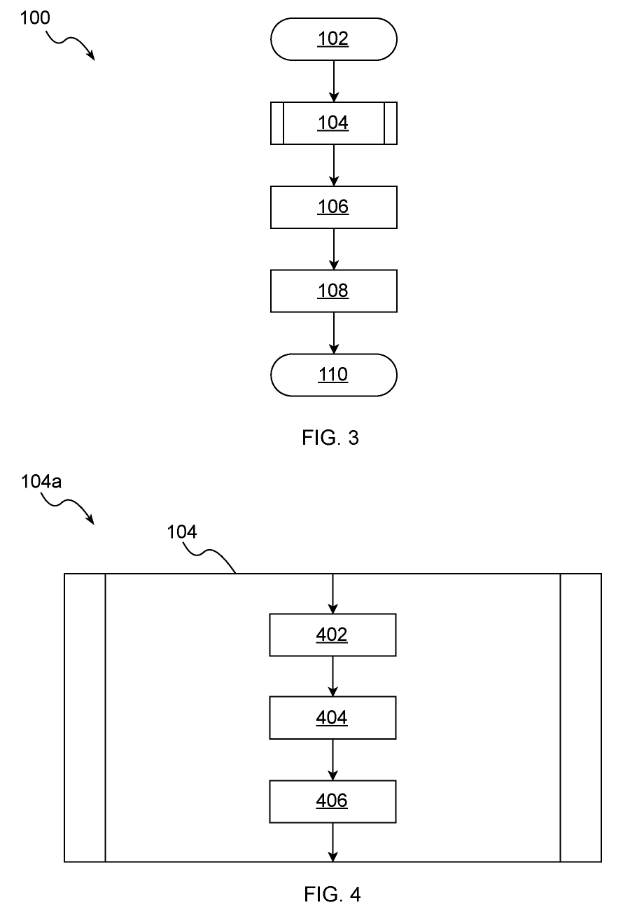

Referring to FIG. 3, a flowchart of the method 100 for controlling vehicle components or electronic devices is provided. It should be understood that the method 100 is applicable to both the system 10a and the system 10b. The method 100 begins at block 102 and proceeds to block 104.

In the context of the system 10a, at block 104, the vehicle controller 14 determines a selected component of the plurality of vehicle components 22, as will be discussed in greater detail below. In the context of the system 10b, at block 104, the room controller 64 determines a selected device of the plurality of electronic devices 68. After block 104, the method 100 proceeds to block 106.

In the context of the system 10a, at block 106, the vehicle controller 14 receives an occupant input using the universal HID 16 to control the selected component. In an exemplary embodiment, the occupant input is a control occupant input. In the scope of the present disclosure, a control occupant input is an occupant input intended to control one of the plurality of vehicle components 22. In a non-limiting example, the control occupant input includes an actuation of a button of the universal HID 16, a rotation of a knob of the universal HID 16, and/or the like.

In the context of the system 10b, at block 106, the room controller 64 receives a user input using the hand-held universal HID 66 to control the selected device. In an exemplary embodiment, the user input is a control user input. In the scope of the present disclosure, a control user input is a user input intended to control one of the plurality of electronic devices 68. In a non-limiting example, the control user input includes an actuation of a button of the hand-held universal HID 66, a rotation of a knob of the hand-held universal HID 66, a physical gesture performed using the hand-held universal HID 66, and/or the like. After block 106, the method 100 proceeds to block 108.

In the context of the system 10a, at block 108, the vehicle controller 14 adjusts the operation of the selected component determined at block 104 based on the occupant input determined at block 106. In a non-limiting example where the selected component is the window 40, the vehicle controller 14 adjusts a position of the window 40 (i.e., opens/closes the window 40) based on the occupant input. For example, if the occupant input includes clockwise rotation of a knob, the vehicle controller 14 closes the window 40 proportional to the amount of rotation. If the occupant input includes counterclockwise rotation of the knob, the vehicle controller 14 opens the window 40 proportional to the amount of rotation. In a non-limiting example where the selected component is the ventilation system 42, the vehicle controller 14 adjusts at least one of: a temperature setpoint of the ventilation system 42 and an airflow level of the ventilation system 42 based on the occupant input. For example, if the occupant input includes clockwise rotation of a knob, the vehicle controller 14 increases the temperature setpoint proportional to the amount of rotation. If the occupant input includes counterclockwise rotation of the knob, the vehicle controller 14 decreases the temperature setpoint proportional to the amount of rotation.

In a non-limiting example where the selected component is the infotainment system 44, the vehicle controller 14 adjusts an audio playback volume of the infotainment system 44 based on the occupant input. For example, if the occupant input includes clockwise rotation of a knob, the vehicle controller 14 increases the audio playback volume proportional to the amount of rotation. If the occupant input includes counterclockwise rotation of the knob, the vehicle controller 14 decreases the audio playback volume proportional to the amount of rotation. In a non-limiting example where the selected component is the door 46, the vehicle controller 14 adjusts at least one of: a door latch state (i.e., whether or not the door 46 is held in a closed position) and a door lock state (i.e., whether or not the door may be unlatched) based on the occupant input. For example, if the occupant input includes actuation of a first button, the vehicle controller 14 unlocks the door latch and lock mechanism 46a. If the occupant input includes actuation of a second button, the vehicle controller 14 locks the door latch and lock mechanism 46a.

In a non-limiting example where the selected component is the seat 48, the vehicle controller 14 adjusts a seat position of the seat 48 based on the occupant input. For example, if the occupant input includes clockwise rotation of a knob, the vehicle controller 14 moves the seat 48 forward proportional to the amount of rotation. If the occupant input includes counterclockwise rotation of the knob, the vehicle controller 14 moves the seat 48 backward proportional to the amount of rotation.

In the context of the system 10b, at block 108, the room controller 64 adjusts the operation of the selected device determined at block 104 based on the user input determined at block 106. In a non-limiting example where the selected device is the room lamp 70, the room controller 64 turns on or off the room lamp 70 based on the occupant input. For example, if the user input includes actuation of a first button, the room controller 64 turns the room lamp 70 on. If the user input includes actuation of a second button, the room controller 64 turns the room lamp 70 off. In a non-limiting example where the selected device is the room window lock 72, the room controller 64 locks or unlocks the room window lock 72 based on the user input. For example, if the user input includes actuation of a first button, the room controller 64 unlocks the room window lock 72. If the user input includes actuation of a second button, the room controller 64 locks the room window lock 72. In a non-limiting example where the selected device is the room ventilation system 74, the room controller adjusts a temperature setpoint of the room ventilation system 74 based on the user input. For example, if the user input includes an upward gesture, the room controller 64 increases the temperature setpoint. If the user input includes a downward gesture, the room controller 64 decreases the temperature setpoint. After block 108, the method 100 proceeds to enter a standby state at block 110.

In an exemplary embodiment, the method 100 repeatedly exits the standby state 110 and restarts at block 102. In a non-limiting example, the method 100 exits the standby state 110 and restarts on a timer, for example, every three hundred milliseconds.

Referring to FIG. 4, a flowchart of a first exemplary embodiment 104a of block 104 is shown. For the first exemplary embodiment 104a of block 104, the one or more indicator devices 18 are not required and the OMS 20 is used, as will be discussed below. The first exemplary embodiment 104a of block 104 begins at block 402. At block 402, the vehicle controller 14 receives an activation occupant input using the universal HID 16. In the scope of the present disclosure, the activation occupant input is an input by the vehicle occupant 82 (FIG. 5) which indicates an intention to activate the gaze detection. After block 402, in response to receiving the activation occupant input, the first exemplary embodiment 104a of block 104 proceeds to block 404.

Referring to FIG. 5, a schematic diagram of an exemplary vehicle interior 80 is shown. The exemplary vehicle interior 80 includes the vehicle occupant 82. With reference to FIGS. 4 and 5, at block 404, in response to receiving the activation occupant input at block 402, the vehicle controller 14 uses the OMS 20 to determine the gaze direction of the vehicle occupant 82. In a non-limiting example, the gaze direction of the vehicle occupant 82 is defined by a gaze direction vector and a gaze origin point. In FIG. 5, the gaze direction of the vehicle occupant 82 is indicated by a dashed line 84. Referring again to FIG. 4, after block 404, the first exemplary embodiment 104a of block 104 proceeds to block 406.

At block 406, the vehicle controller 14 identifies the selected component based at least in part on the gaze direction determined at block 404. In an exemplary embodiment, to identify the selected component, the vehicle controller 14 executes a gaze intersection machine learning algorithm. In a non-limiting example, the gaze intersection machine learning algorithm is a machine learning algorithm trained on a labeled dataset of gaze direction vectors and gaze origin points and corresponding selected components. In another exemplary embodiment, to identify the selected component, the vehicle controller 14 projects the gaze direction vector into a three-dimensional model of the interior of the vehicle 12 based on the gaze origin point. The vehicle controller 14 then identifies the selected component to be one of the plurality of vehicle components 22 that the projected gaze direction vector intersects with. It should be understood that the techniques for identifying the selected component based at least in part on the gaze direction discussed above are merely exemplary in nature, and that additional methods for identifying the selected component based at least in part on the gaze direction are within the scope of the present disclosure. After block 406, the first exemplary embodiment 104a of block 104 is concluded, and the method 100 proceeds as discussed above.

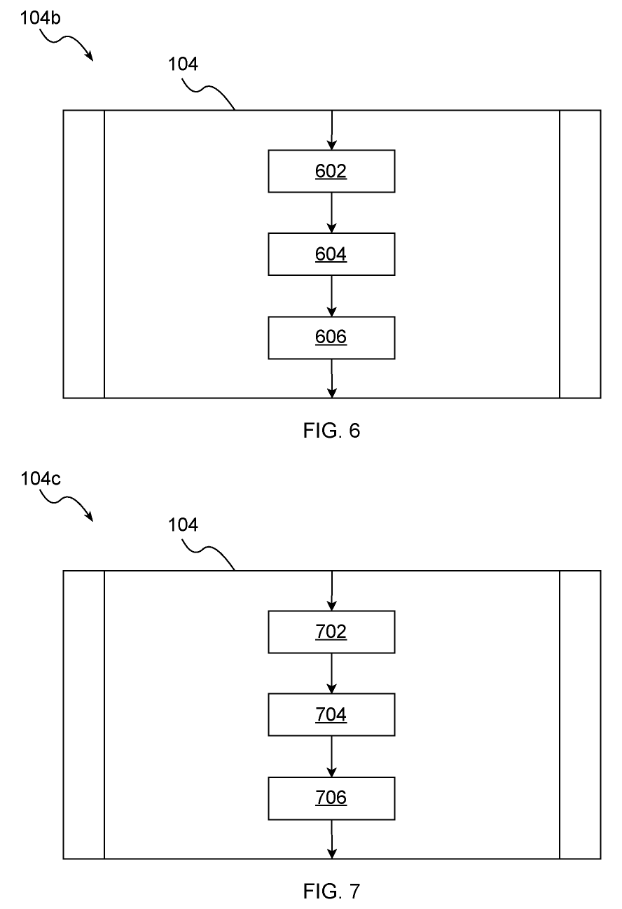

Referring to FIG. 6, a flowchart of a second exemplary embodiment 104b of block 104 is shown. For the second exemplary embodiment 104b of block 104, the OMS 20 is not required and the one or more indicator devices 18 are used, as will be discussed below. The second exemplary embodiment 104b of block 104 begins at block 602. At block 602, the vehicle controller 14 receives a first selection occupant input using the universal HID 16. In the scope of the present disclosure, the selection occupant input is an occupant input intended to select one of the plurality of vehicle components 22. In a non-limiting example, the selection occupant input includes rotation of a knob of the universal HID 16. In another non-limiting example, the selection occupant input includes actuation of a button of the universal HID 16. After block 602, the second exemplary embodiment 104b of block 104 proceeds to block 604.

At block 604, the vehicle controller 14 indicates a first component of the plurality of vehicle components 22 in response to receiving the first selection occupant input at block 602. In an exemplary embodiment, to indicate the first component, the vehicle controller 14 uses one of the one or more indicator devices 18. In a non-limiting example, vehicle controller 14 uses the laser 30 to provide a focused light source indicating the first component. In another non-limiting example, the vehicle controller 14 uses the one or more LEDs 32 to illuminate on or near the first component, to provide a spotlight illuminating the first component, and/or to provide a projection indicating the first component. If the first component is a user interface (UI) element displayed on the HMI of the infotainment system 44, the vehicle controller 14 displays a graphic on the HMI indicating the UI element. In another non-limiting example, the vehicle controller 14 uses the audio source 34 to announce the selected element to the vehicle occupant 82.

If a second selection occupant input is received, the vehicle controller 14 uses the one or more indicator devices 18 to indicate a second component of the plurality of vehicle components 22. In an exemplary embodiment, the second component is determined based at least in part on the first component and the second selection occupant input. In a non-limiting example, if the second selection occupant input includes a clockwise rotation of a knob, the second component is determined to be one of the plurality of vehicle components 22 which is located in a clockwise direction relative to the first component from the perspective of the universal HID 16. In a non-limiting example, if the second selection occupant input includes a counterclockwise rotation of a knob, the second component is determined to be one of the plurality of vehicle components 22 which is located in a counterclockwise direction relative to the first component from the perspective of the universal HID 16. After block 604, the second exemplary embodiment 104b of block 104 proceeds to block 606.

At block 606, the vehicle controller 14 uses the universal HID 16 to receive a confirmation occupant input. In the scope of the present disclosure, the confirmation occupant input is an occupant input intended indicate the desire to adjust the operation of the first component illuminated at block 604. Therefore, after receiving the confirmation occupant input, the first component is determined to be the selected component as discussed above. In a non-limiting example, the confirmation occupant input includes actuation of a predetermined button of the universal HID 16 (e.g., a “select” or “OK” button). After block 606, the second exemplary embodiment 104b of block 104 is concluded, and the method 100 proceeds as discussed above.

Referring to FIG. 7, a flowchart of a third exemplary embodiment 104c of block 104 is shown. Referring to FIGS. 2 and 7, the third exemplary embodiment 104c of block 104 utilizes the system 10b. The third exemplary embodiment 104c of block 104 begins at block 702. At block 702, the room controller 64 determines the orientation of the hand-held universal HID 66 in three-dimensional space. In an exemplary embodiment, the hand-held universal HID 66 uses the one or more position or orientation sensors to determine the orientation of the hand-held universal HID 66 in three-dimensional space. After block 702, the third exemplary embodiment 104c of block 104 proceeds to block 704.

At block 704, the room controller 64 determines a pointing direction of the hand-held universal HID 66 based at least in part on the orientation of the hand-held universal HID 66 determined at block 702. In the scope of the present disclosure, the pointing direction is defined as a direction along a normal vector of a plane defining a front of the hand-held universal HID 66. Referring to FIG. 2, an example of the pointing direction is illustrated by a dashed line 86. In an exemplary embodiment, the pointing direction is defined by a pointing direction vector and a pointing direction origin point. In a non-limiting example, to determine the pointing direction, the room controller 64 receives the orientation of the hand-held universal HID 66 from the hand-held universal HID 66 and uses a mathematical model of the hand-held universal HID 66 to determine the pointing direction based on the orientation of the hand-held universal HID 66 and the geometry of the hand-held universal HID 66. After block 704, the third exemplary embodiment 104c of block 104 proceeds to block 706.

At block 706, the room controller 64 identifies the selected device based at least in part on the pointing direction determined at block 704. In an exemplary embodiment, to identify the selected device, the room controller 64 executes a pointing direction intersection machine learning algorithm. In a non-limiting example, the pointing direction intersection machine learning algorithm is a machine learning algorithm trained on a labeled dataset of pointing direction vectors and pointing direction origin points and corresponding selected devices in the room 62. In another exemplary embodiment, to identify the selected component, the vehicle controller 14 projects the pointing direction vector into a three-dimensional model of the room 62 based on the pointing direction origin point. The room controller 64 then identifies the selected device to be one of the plurality of electronic devices 68 that the projected pointing direction vector intersects with. It should be understood that the techniques for identifying the selected device based at least in part on the pointing direction discussed above are merely exemplary in nature, and that additional methods for identifying the selected device based at least in part on the pointing direction are within the scope of the present disclosure. After block 706, the third exemplary embodiment 104c of block 104 is concluded, and the method 100 proceeds as discussed above.

The systems 10a, 10b and method 100 of the present disclosure offer several advantages. Using the systems 10a, 10b, vehicle occupants or users with reduced mobility or movement ability may operate features of the vehicle or control electronic devices with minimal physical movement. Using the system 10a, vehicle occupants may adjust the operation of vehicle components which would otherwise be out of reach. Furthermore, using the system 10a, vehicle occupants may intuitively select vehicle components for control based on gaze direction. Using the system 10b, users may adjust the operation of electronic devices (e.g., smart-home devices) intuitively and efficiently.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for controlling vehicle components for a vehicle, the system comprising:
a plurality of vehicle components;
a universal human-interface-device (HID) operable to receive an occupant input and control any of the plurality of vehicle components; and
a vehicle controller in electrical communication with the plurality of vehicle components and the universal HID, wherein the vehicle controller is programmed to:
determine a selected component of the plurality of vehicle components;
receive the occupant input using the universal HID; and
adjust an operation of the selected component based at least in part on the occupant input.

2. The system of claim 1, further comprising an occupant monitoring system (OMS) in electrical communication with the vehicle controller and operable to determine a gaze direction of a vehicle occupant, and wherein to determine the selected component, the vehicle controller is further programmed to:
receive an activation occupant input using the universal HID;
determine the gaze direction of the vehicle occupant using the OMS in response to receiving the activation occupant input; and
identify the selected component based at least in part on the gaze direction.

3. The system of claim 1, wherein to determine the selected component, the vehicle controller is further programmed to:
receive a first selection occupant input using the universal HID;
indicate a first component of the plurality of vehicle components to a vehicle occupant;
receive a confirmation occupant input using the universal HID; and
determine the first component to be the selected component in response to receiving the confirmation occupant input.

4. The system of claim 3, wherein to determine the selected component, the vehicle controller is further programmed to:
receive a second selection occupant input using the universal HID; and
indicate a second component of the plurality of vehicle components to the vehicle occupant in response to receiving the second selection occupant input.

5. The system of claim 3, further comprising a light source in electrical communication with the vehicle controller and disposed within an interior of the vehicle, wherein to indicate the first component, the vehicle controller is further programmed to:
illuminate the light source to visually indicate the first component to the vehicle occupant.

6. The system of claim 5, wherein the light source further comprises at least one of: a spotlight, a laser, a projector, and one or more light emitting diodes (LEDs) operable to selectively illuminate one or more of the plurality of vehicle components.

7. The system of claim 3, further comprising an audio source in electrical communication with the vehicle controller and disposed within an interior of the vehicle, wherein to indicate the first component, the vehicle controller is further programmed to:
produce a sound using the audio source to audibly indicate the first component to the vehicle occupant.

8. The system of claim 1, wherein the universal HID includes one or more tactile interfaces fixed within reach of one or more vehicle occupants within an interior of the vehicle.

9. The system of claim 8, wherein to receive the occupant input using the universal HID and adjust the operation of the selected component, the vehicle controller is further programmed to:
receive a control occupant input using the universal HID;
adjust the operation of the selected component based at least in part on the control occupant input; and
provide haptic feedback or force feedback using the universal HID in response to adjusting the operation of the selected component.

10. The system of claim 9, wherein the plurality of vehicle components includes at least one of: a window of the vehicle, a ventilation system of the vehicle, an infotainment system of the vehicle, a door of the vehicle, and a seat of the vehicle, and wherein to adjust the operation of the selected component, the vehicle controller is further programmed to:
adjust a position of the window based at least in part on the control occupant input in response to determining that the selected component is the window;
adjust at least one of: a temperature setpoint and an airflow level based at least in part on the control occupant input in response to determining that the selected component is the ventilation system;
adjust an audio playback volume based at least in part on the control occupant input in response to determining that the selected component is the infotainment system;
adjust at least one of: a door latch state and a door lock state based at least in part on the control occupant input in response to determining that the selected component is the door; and
adjust a seat position based at least in part on the control occupant input in response to determining that the selected component is the seat.

11. A method for controlling vehicle components for a vehicle, the method comprising:
determining a selected component of a plurality of vehicle components;
receiving an occupant input using a universal human-interface-device (HID); and
adjusting an operation of the selected component based at least in part on the occupant input.

12. The method of claim 11, wherein determining the selected component further comprises:
receiving an activation occupant input from a vehicle occupant using the universal HID;
determining a gaze direction of the vehicle occupant using an occupant monitoring system (OMS) in response to receiving the activation occupant input; and
identifying the selected component based at least in part on the gaze direction.

13. The method of claim 11, wherein determining the selected component further comprises:
receiving a first selection occupant input using the universal HID;
indicating a first component of the plurality of vehicle components to a vehicle occupant;
receiving a confirmation occupant input using the universal HID; and
determining the first component to be the selected component in response to receiving the confirmation occupant input.

14. The method of claim 13, wherein indicating the first component further comprises:
illuminating a light source to visually indicate the first component to the vehicle occupant, wherein the light source includes at least one of: a spotlight, a laser, a projector, and one or more light emitting diodes (LEDs) operable to selectively illuminate one or more of the plurality of vehicle components.

15. The method of claim 11, wherein receiving the occupant input using the universal HID further comprises:
receiving the occupant input using the universal HID, wherein the universal HID includes one or more tactile interfaces fixed within reach of one or more vehicle occupants within an interior of the vehicle, and wherein the universal HID is operable to provide haptic feedback.

16. The method of claim 15, wherein receiving the occupant input using the universal HID and adjusting the operation of the selected component further comprises:
receiving a control occupant input using the universal HID;
adjusting the operation of the selected component based at least in part on the control occupant input; and
providing haptic feedback using the universal HID in response to adjusting the operation of the selected component.

17. The method of claim 16, wherein adjusting the operation of the selected component further comprises:
adjusting a position of a window based at least in part on the control occupant input in response to determining that the selected component is the window;
adjusting at least one of: a temperature setpoint and an airflow level based at least in part on the control occupant input in response to determining that the selected component is a ventilation system;
adjusting an audio playback volume based at least in part on the control occupant input in response to determining that the selected component is an infotainment system;
adjusting at least one of: a door latch state and a door lock state based at least in part on the control occupant input in response to determining that the selected component is a door; and
adjusting a seat position based at least in part on the control occupant input in response to determining that the selected component is a seat.

18. A system for controlling electronic devices, the system comprising:
a plurality of electronic devices;
a universal human-interface-device (HID) operable to receive a user input and control any of the plurality of electronic devices; and
a controller in electrical communication with the plurality of electronic devices and the universal HID, wherein the controller is programmed to:
determine a selected device of the plurality of electronic devices using the universal HID based at least in part on an orientation of the universal HID in three-dimensional space;
receive the user input using the universal HID; and
adjust an operation of the selected device based at least in part on the user input.

19. The system of claim 18, wherein to determine the selected device, the controller is further programmed to:
determine the orientation of the universal HID in three-dimensional space;
determine a pointing direction of the universal HID based at least in part on the orientation of the universal HID; and
determine the selected device based at least in part on the pointing direction of the universal HID.

20. The system of claim 19, wherein to receive the user input using the universal HID and adjust the operation of the selected device, the controller is further programmed to:
receive a control user input using the universal HID, wherein the control user input includes at least one of: actuation of a button of the universal HID and performance of a physical gesture using the universal HID;
adjust the operation of the selected device based at least in part on the control user input; and
provide haptic feedback using the universal HID in response to adjusting the operation of the selected device.
